(19) United States
(12) Patent Application Publication
(10) Pub. No.: US 2014/0218265 A1
(43) Pub. Date: Aug. 7, 2014

(54) METAMATERIAL STRUCTURE AND THE METHOD OF MANUFACTURING THE SAME

(71) Applicant: NATIONAL APPLIED RESEARCH LABORATORIES, Taipei (TW)

(72) Inventors: Che-Chin Chen, Hsinchu (TW); Yu-Hsiang Tang, Hsinchu (TW); Chun-Ting Lin, Hsinchu (TW); Ming-Hua Shiao, Hsinchu (TW); Din Ping Tsai, Taipei (TW)

(21) Appl. No.: 13/836,427

(22) Filed: Mar. 15, 2013

(30) Foreign Application Priority Data
Feb. 6, 2013 (TW) 102104695

(51) Int. Cl. H01Q 15/10

(52) U.S. Cl. CPC H01Q 15/10
USPC 343/911 R

(57) ABSTRACT

A metamaterial structure and method of manufacturing the same are disclosed. The metamaterial includes a substrate, a first resonance unit and a second resonance unit. The surface of the substrate has a bump. The first resonance unit and the second resonance unit are disposed on an adhesive direction from the bump, whereby forming the sterical resonance unit, which is able to increase the coupling efficiency of incident light in some specific frequency and form an in-situ reconfigurable metamaterial.

### CROSS-REFERENCE TO RELATED APPLICATION

This application claims the benefit of Taiwan Patent Application No. 102104695, filed on Feb. 6, 2013, in Taiwan Intellectual Property Office of Republic of China, the disclosure of which is incorporated herein in its entirety by reference.

### FIELD OF THE INVENTION

The present invention relates to a metamaterial structure and a method of manufacturing the metamaterial structure, and more particularly to the metamaterial structure with a split-ring resonance structure and the manufacturing method of the metamaterial structure.

### BACKGROUND OF THE INVENTION

Optical metamaterial is an artificial synthetic structure or medium with a left-handed (LH) property. More specifically, people can control the electromagnetic property of the metamaterial by the geometric shape and design of elements of the metamaterial. Unlike right-handed (RH) materials, the metamaterials have negative values of permittivity (dielectric constant, ε) and/or permeability (μ). In other words, the metamaterials may have a negative refractive index.

At present, common metamaterial structures are in various geometric shapes such as a linear shape, a mesh shape and a split-ring shape, and the array and orientation of the basic geometric shapes of the metamaterials can produce special reflection, transmission and absorption spectrum. For example, if an incident light with a specific wavelength encounters with split-ring metamaterials, the magnetic field and the electric field of the light could resonate with the metamaterial to provide the features of electric response, magnetic response or toroidal response.

Split ring resonators used for metamaterials mainly resides on that the magnetic response has a negative permeability. However, a split-ring array 10 of a conventional metamaterial structure 99 as shown in FIG. 1 has surfaces on a 2D plane. To produce the magnetic response of the split-ring array 10 by the magnetic field of the incident light, then the magnetic field of the incident light should have a component at the normal direction of the split-ring surface. Therefore, the coupling of the incident light and the metamaterial 99 is limited.

### SUMMARY OF THE INVENTION

In view of the aforementioned problem of the prior art, it is a primary objective of the present invention to provide a metamaterial structure and a method of manufacturing the metamaterial structure with a 3D split-ring array structure to overcome the limitation of the optical coupling of the incident light on the metamaterial with the 2D split-ring array structure.

To achieve the aforementioned objective, the present invention provides a metamaterial structure, comprising a substrate, a first resonance unit and a second resonance unit. Wherein, a bump is formed on a surface of the substrate; the first resonance unit includes a first adhesive element and a first arm, and the first adhesive element is disposed along an adhesive direction of the bump, and the first arm is extended outwardly from the first adhesive element. The second resonance unit includes a second adhesive element and a second arm, and the second adhesive element is disposed along the adhesive direction of the first adhesive element, and the second arm is extended outwardly from the second adhesive element and curled in an opposite direction from a surface of the substrate.

Preferably, metamaterial structure further comprises an adhesive portion coupled to the first adhesive element and the second adhesive element, and the bump is coupled to the substrate and the first adhesive element, and the adhesive portion has an appearance smaller than the first adhesive element and the second adhesive element, and the bump has an appearance smaller than the first adhesive element.

Preferably, the first adhesive element has a first sidewall, and the second adhesive element has a second sidewall, and the first arm is extended outwardly from the first sidewall, and the portion of the first arm coupled to the first adhesive element has an appearance smaller than the first sidewall, and the second arm is extended outwardly from the second sidewall, and the portion of the second arm coupled to the second adhesive element has an appearance smaller than the second sidewall.

To achieve the aforementioned objective, the present invention provides a manufacturing method of a metamaterial structure, comprising the steps of: providing a substrate, and defining a contour on a surface of the substrate, wherein the contour includes an adhesive area and an arm area extended outwardly from the adhesive area; depositing a first metal layer on the substrate; depositing a connecting layer on the first metal layer; depositing a second metal layer on the connecting layer, wherein the second metal layer has a stress for curling in an opposite direction from a surface of the substrate; forming contours of the first metal layer, the second metal layer and the connecting layer by a lift-off process; and etching the arm area and a portion of the connecting layer corresponding to the arm area to curl the second metal layer corresponding to the portion of the contour of the arm area to form the metamaterial structure.

Preferably, the arm area is extended outwardly from a side of the adhesive area and the portion of the arm area coupled to the adhesive area is smaller than the side of the adhesive area.

Preferably, the step of etching the arm area and the portion of the substrate corresponding to the contour of the arm area is performed by using a dry etching method or a wet etching method.

Preferably, the step of defining the contour is performed by using an electron beam lithography, a photolithography, a focused ion beam, a nano imprinting or a laser direct beam.

To achieve the aforementioned objective, the present invention further provides a metamaterial structure, comprising a substrate, and a first resonance unit. The substrate surface has a first bump, and the first resonance unit includes a first adhesive element and a first arm. The first adhesive element is adhered onto the first bump and the first arm is extended outwardly from the first adhesive element and curled in an opposite direction from a surface of the substrate.

Preferably, a gap is formed between the first arm and the surface of the substrate.

Preferably, the first arm is extended outwardly from a sidewall of the first adhesive element, and the portion of the first arm coupled to the first adhesive element has an appearance smaller than the appearance of the sidewall.

Preferably, the first resonance unit further includes a second arm, and the first adhesive element has a first sidewall and a second sidewall disposed opposite to each other, and the first arm is extended outwardly from the first sidewall, and the second arm is extended outwardly from the second sidewall, and the portion of the first arm coupled to the first adhesive element has an appearance smaller than the appearance of the first sidewall, and the portion of the second arm coupled to the first adhesive element has an appearance smaller than the appearance of the second sidewall.

Preferably, the first arm has a length equal to or greater than the length of the second arm, and a gap is formed between the first arm and the second arm.

To achieve the aforementioned objective, the present invention further provides a metamaterial structure, comprising a substrate and a plurality of resonance units. The substrate surface has a plurality of bumps arranged in to a circular array or a rectangular array. The resonance units are coupled to the bumps one by one, and the resonance unit is the first resonance unit mentioned above.

In summation, the metamaterial structure of the present invention has a 3D and free standing split ring resonance structure, so that the higher coupling efficiency and magnetic responses of an incident light with a specific frequency can be obtained and for manufacturing an in-situ reconfigurable metamaterial by changing environmental conditions such as temperature, magnetic field, or electric field.

### BRIEF DESCRIPTION OF THE DRAWINGS

FIG. 1 is a schematic view of a conventional 2D split ring resonance structure.

FIG. 2A is a perspective view of a metamaterial structure according to a first preferred embodiment of the present invention.

FIG. 2B is a cross-sectional view in the Z-X plane of a metamaterial structure according to the first preferred embodiment of the present invention.

FIGS. 3A to 3D show a flow chart of a manufacturing method according to the first preferred embodiment of the present invention.

FIG. 4A is a perspective view of a metamaterial structure according to a second preferred embodiment of the present invention.

FIG. 4B is a cross-sectional view in the X-Z plane of a metamaterial structure according to the second preferred embodiment of the present invention.

FIG. 5 is a perspective view of a metamaterial structure according to a third preferred embodiment of the present invention.

FIG. 6 is a perspective view of a metamaterial structure according to a fourth preferred embodiment of the present invention.

FIG. 7 is a perspective view of a metamaterial structure according to a fifth preferred embodiment of the present invention.

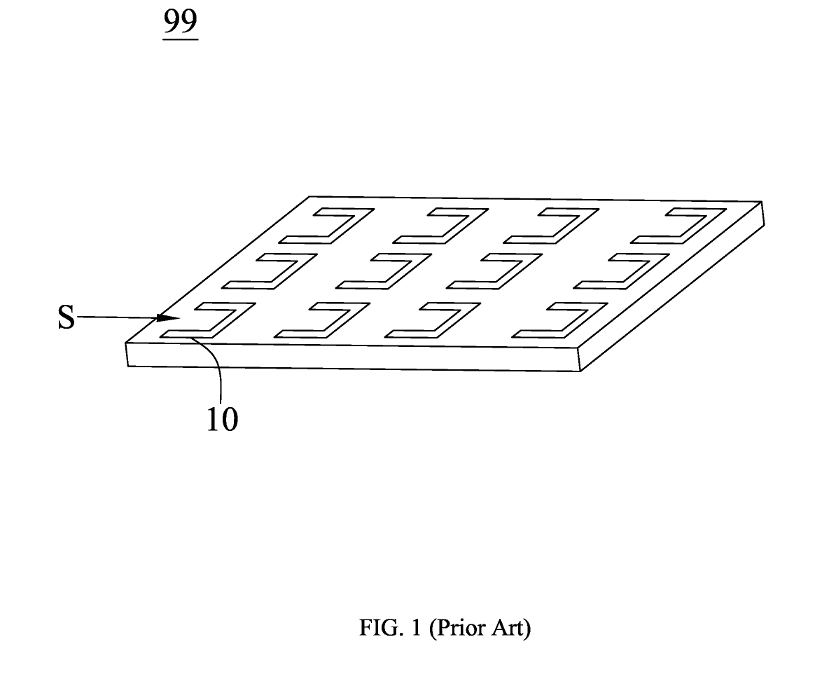

### DESCRIPTION OF THE PREFERRED EMBODIMENTS

The technical characteristics, contents, advantages and effects of the present invention will be apparent with the detailed description of a preferred embodiment accompanied with related drawings as follows. It is noteworthy that same numerals are used to represent respective elements in the following preferred embodiments.

The metamaterial structure mentioned in this specification is used for producing resonance with a light with a specific wavelength, or the metamaterial structure of the present invention can produce a negative permeability or negative refractive index effect under the light with specific wavelength. Therefore, the metamaterial structure of the present invention is a periodical structure with sub-wavelength of the light wave. In addition, the term “curl” also refers to warping in a specific direction.

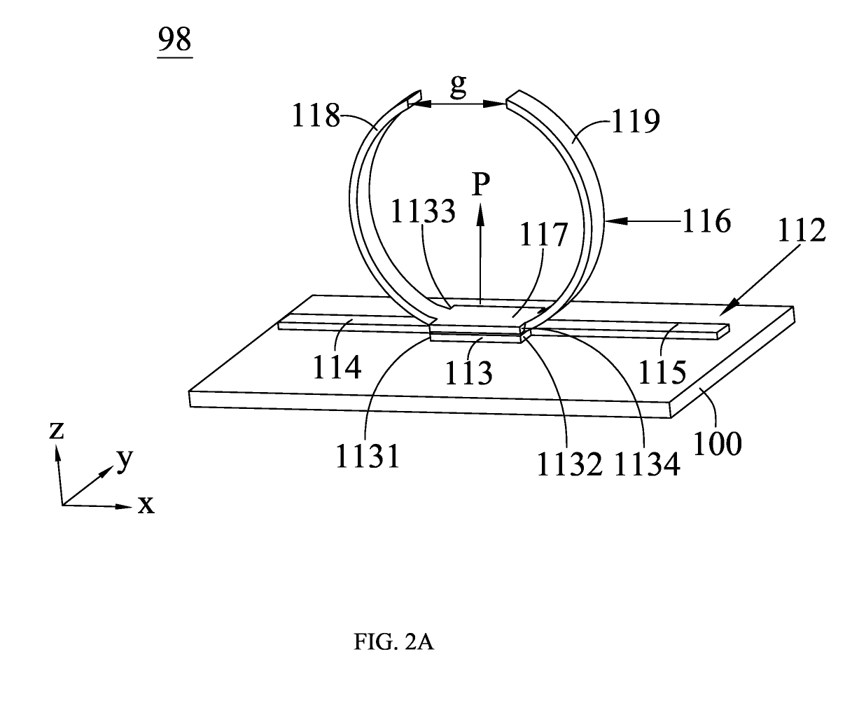

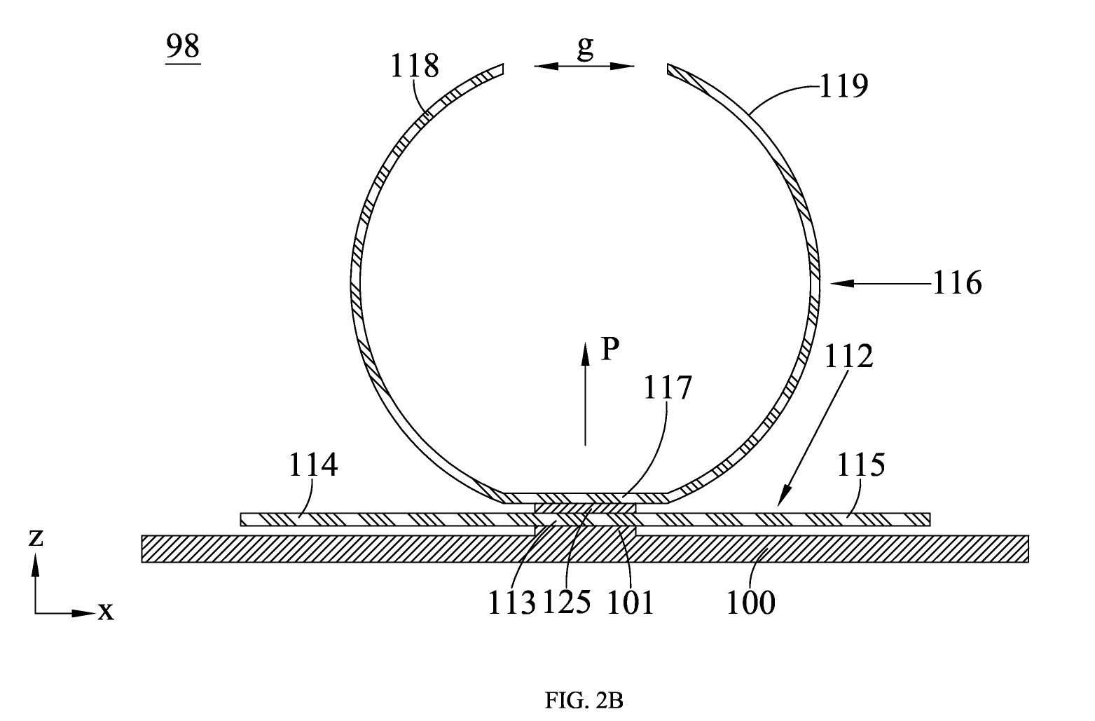

With reference to FIGS. 2A and 2B for a perspective view of a metamaterial structure and a cross-sectional view in the Z-X plane of the metamaterial structure according to the first preferred embodiment of the present invention respectively, the metamaterial structure 98 comprises a substrate 100, a first resonance unit 112 and a second resonance unit 116, wherein a bump 101 is formed on a surface of the substrate 100, and the substrate 100 and the bump 101 are made of the same material. In other words, the bump 101 is a structure extended and protruded from the substrate 100.

The first resonance unit 112 includes a first adhesive element 113 and a first arm 114, 115, wherein the first adhesive element 113 is disposed along an adhesive direction P of the bump 101, and the first arms 114, 115 are extended outwardly from the first adhesive element 113.

In this preferred embodiment, the adhesive direction P is perpendicular to the surface of the substrate 100, but the invention is not limited to such arrangement only. In other preferred embodiments of the present invention, the adhesive direction P can be roughly perpendicular to the surface of the substrate 100.

In this preferred embodiment, there are two first arms 114, 115, but the invention is not limited to such arrangement only. In other preferred embodiments of the present invention, there can be one or more arms.

The second resonance unit 116 includes a second adhesive element 117 and a second arm 118, 119. Wherein, the second adhesive element 117 is disposed along an adhesive direction p of the first adhesive element 113. The connection between the second arms 118, 119 and the second adhesive element 117 is similar to the connection between the first arms 114, 115 and the first adhesive element 113, and thus will not be repeated.

It is noteworthy that the second arms 118, 119 of this preferred embodiment are not the same as the first arms 114, 115 which are substantially parallel to the surface of the substrate 100, but he second arms 118, 119 are curled in an opposite direction from the surface of the substrate 100, and a gap g is defined between an end of the second arm 118 and an end of the second arm 119.

Since the first resonance unit 116 of this preferred embodiment has a gap g, therefore when the magnetic field of the incident light has a component existed in the normal direction of the Z-X plane of the first resonance unit 116, the first resonance unit 116 will produce a magnetic resonance to the light wave with the specific frequency, wherein the size of the gap g can be used for adjusting the resonance frequency of light wave. Since this preferred embodiment has a 3D split-ring structure, it is easily to have a largest magnetic field component of the incident light along the Z-X plane and leading to a strongest magnetic response with the structure. In addition, the second resonance unit 112 of this preferred embodiment can produce an electrical resonance with the incident electromagnetic wave to have the feature of negative permittivity. With the split-ring structure of the first resonance unit 116 and the structure of the second resonance unit 112 being parallel to the arms of the substrate 100, the metamaterial structure 98 has the effect of negative refractive index.

It is noteworthy that the metamaterial structure of this preferred embodiment further comprises an adhesive portion 125 coupled to the first adhesive element 113 and the second adhesive element 117, and the bump 101 is coupled to the substrate 100 and the first adhesive element 113, and the adhesive portion 125 has an appearance smaller than the first adhesive element 113 and the second adhesive element 117, and the bump 101 and an appearance smaller than the first adhesive element 113. The adhesive portion 125 is made of the same material of the substrate 100 and jointly formed with the bump 101 in the same manufacturing process.

The first adhesive element 113 has a first sidewall 1131 and a second sidewall 1132 disposed opposite to each other. Each first arm 114, 115 is extended outwardly from the first sidewall 1131 and the second sidewall 1132, and the portion of each first arm 114, 115 coupled to the first adhesive element 113 has an appearance smaller than the appearance of the first sidewall 1131 and the second sidewall 1132. Similarly, the connection between the second arms 118, 119 and the third sidewall 1133 and the fourth sidewall 1134 of the second adhesive element 117 is similar to the connection between the first arms 114, 115 and the first adhesive element 113.

Since the sidewalls of the first adhesive element 113 and the second adhesive element 117 are greater than the appearance of the connecting portion of the first arms 114, 115 and the second arms 118, 119, therefore the first adhesive element 113 and the second adhesive element 117 can provide a better connectivity of the first arms 114, 115 and the second arms 118, 119. Particularly, when the second arms 118, 119 are curled, the second adhesive element 117 having a greater appearance can provide an adhesive point for the second arms 118, 119.

It is noteworthy to point out that the whole 3D metal metamaterial structure of this preferred embodiment except the adhesive element is free standing on the structure of the substrate, so that an external environmental change such as a change of temperature, electric field or magnetic field can be used for adjusting the geometric appearance and changing the resonance frequency to manufacture an in-situ reconfigurable metamaterial.

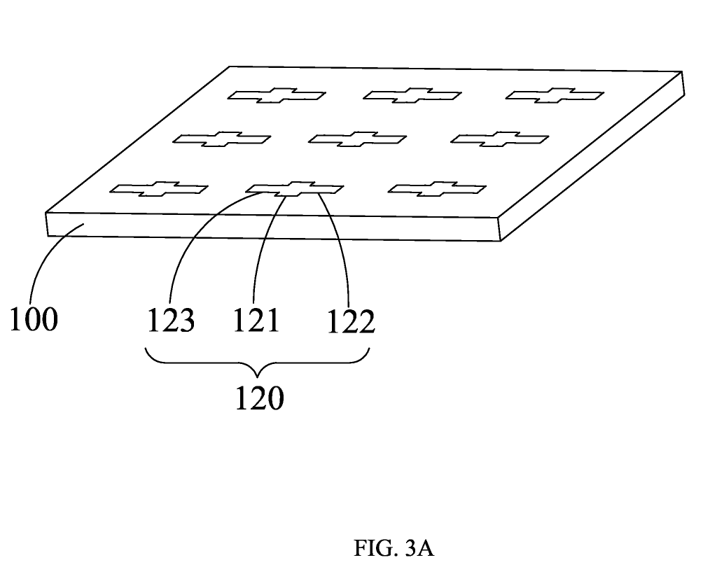

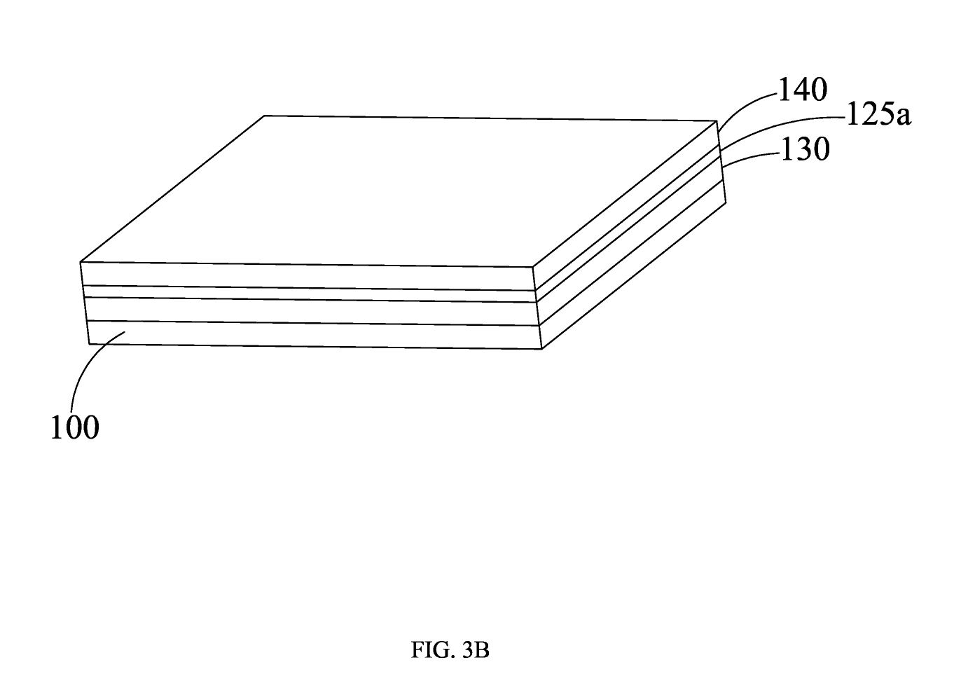

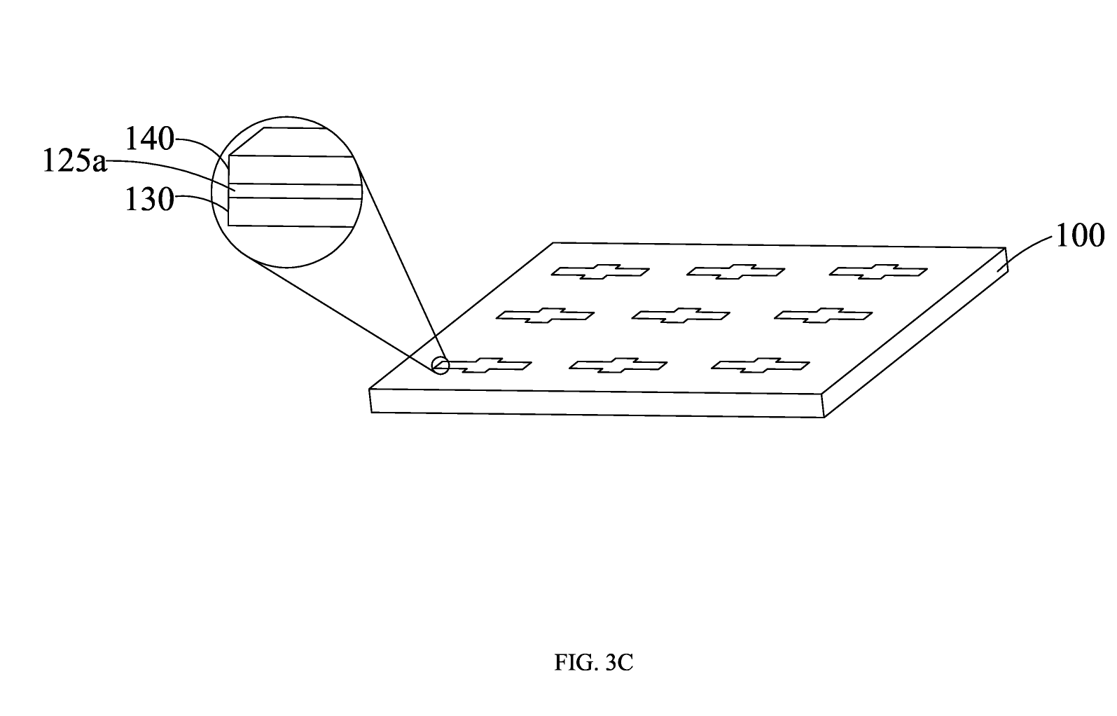

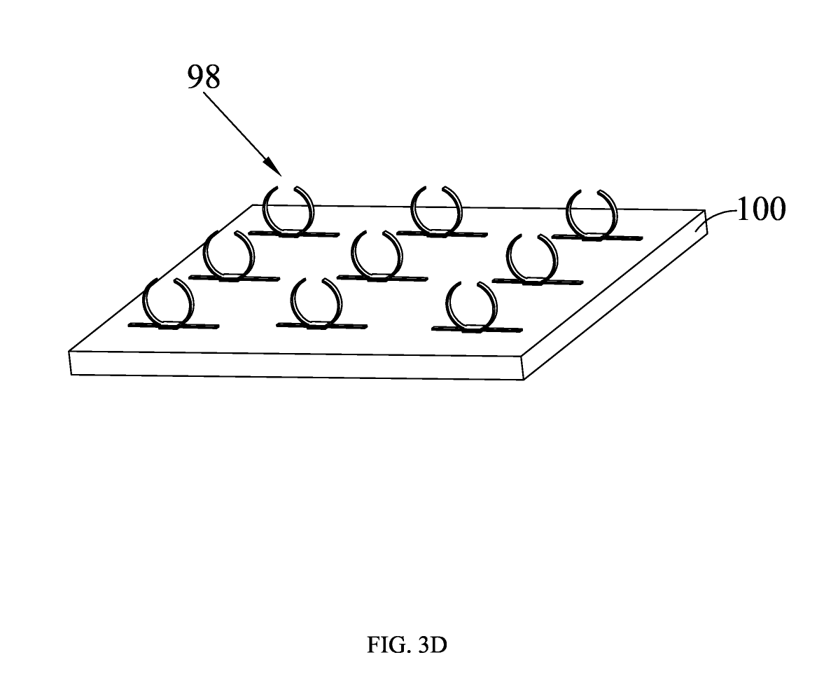

With reference to FIGS. 3A to 3D for the manufacturing flow chart of the first preferred embodiment of the present invention, the manufacturing method comprises the following steps. In FIG. 3A, a substrate 100 is provided, and a contour 120 is defined on a surface of the substrate 100, wherein the contour 120 includes an adhesive area 121 and arm areas 122, 123 extended outwardly from the adhesive area. In this preferred embodiment, electron beam lithography is used for defining the contour 120, but the invention is not limited to such arrangement only. In other preferred embodiments of the present invention, other methods such as photolithography, focused ion beam, nano imprinting or laser direct beam can be used to define the contour 120 as well.

It is noteworthy that the portion of the adhesive area 121 coupled to the arm areas 122, 123 of this preferred embodiment has a longer perimeter than that of the arm areas 122, 123. In this preferred embodiment, the adhesive area 121 is in a rectangular shape, but the present invention is not limited to this shape only.

In FIG. 3B, a first metal layer 130 is deposited on the substrate 100, and a connecting layer 125a is deposited on the first metal layer 130, and then a second metal layer 140 is deposited on the connecting layer 125a. When the first metal layer 130 and the second metal layer 140 are deposited, they are formed by one metal or more than one metal layer to obtain different metal stresses. In this preferred embodiment, the second metal layer 140 is designed with a stress for curling in an opposite direction from the surface of the substrate 100, and the first metal layer 130 is designed without the curling stress. Since the structure of this preferred embodiment is made of metal, external environmental changes such as a change of temperature, a change of electric field, or an existence of magnetic field could be used to control the appearance and the extent of the curl.

In 3C, the first metal layer 130, connecting layer 125a, and the second metal layer 140 are patterned to form contours 120 of the first metal layer 130, connecting layer 125a, and the second metal layer 140 as shown in FIG. 3A. Wherein, the first metal layer 130, connecting layer 125a, and second metal layer 140 can be patterned by a lift-off process which is a prior art well known by persons ordinarily skilled in the art, and thus will not be described in details.

In FIG. 3D, the connecting layer 125a under the arm area 122 and the substrate 100 are etched, so that the second metal layer 140 with the metal stress corresponding to the contour portions of the arm areas 122, 123 as shown in FIG. 3A a curled to form a 3D split ring resonance structure. In other words, several metamaterial structures 98 are formed as shown in FIG. 2A. In this preferred embodiment, a dry etching method and a plasma gas (C₄F₈) are used for etching the substrate, but the invention is not limited to such method only. In other preferred embodiments of the present invention, a wet etching method can be used for etching the substrate as well.

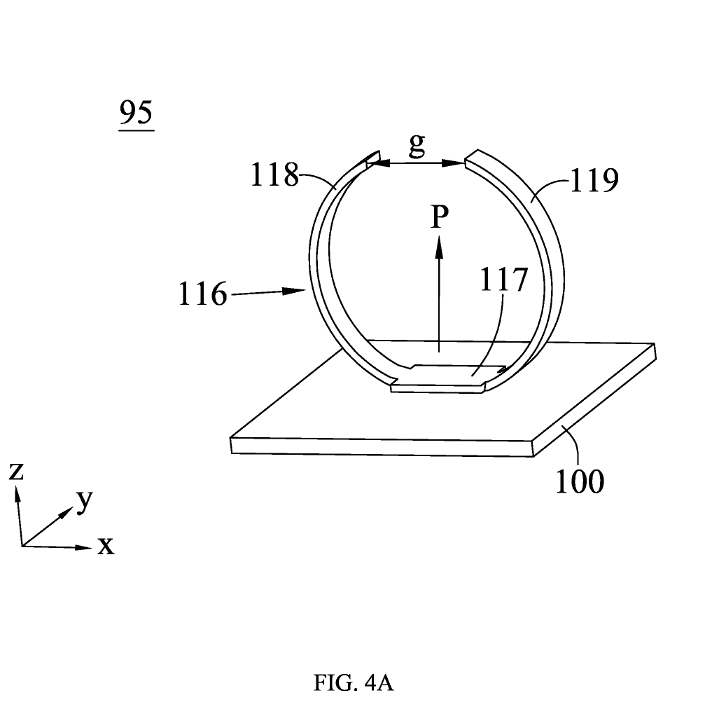

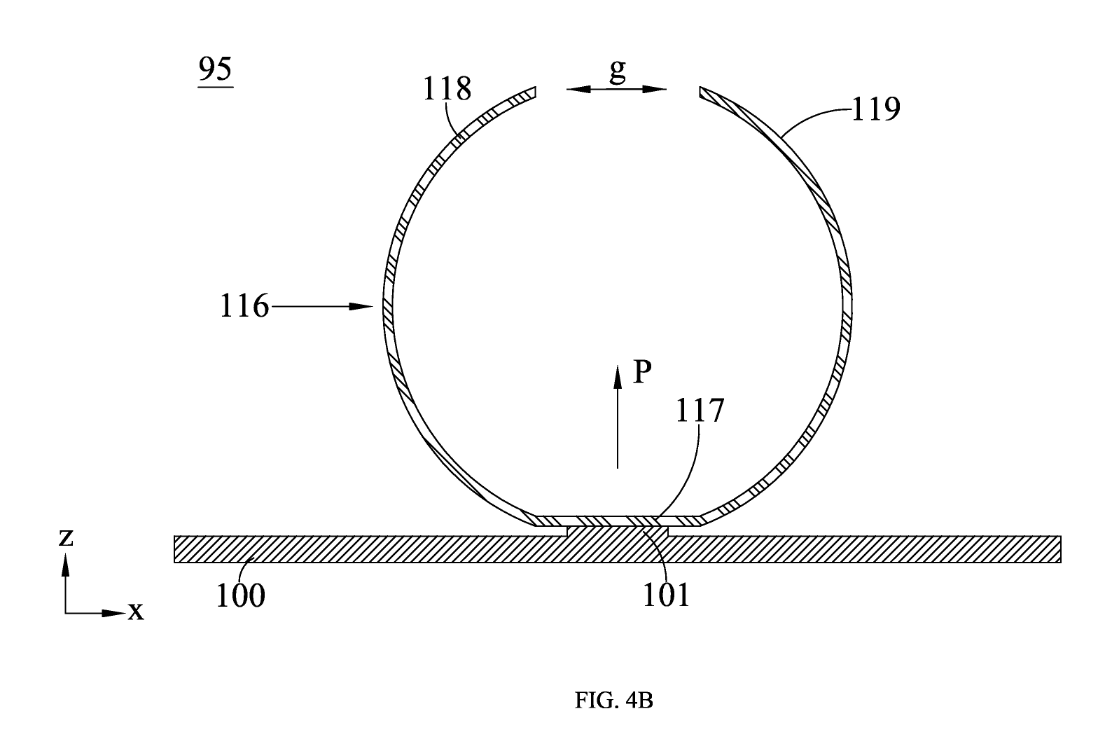

With reference to FIGS. 4A and 4B for a perspective view of a metamaterial structure and a cross-sectional view of a metamaterial structure in the X-Z plane of a metamaterial structure according to the second preferred embodiment of the present invention respectively, the major difference between the metamaterial structure 95 of the second preferred embodiment with the metamaterial structure of the first preferred embodiment resides on that the second preferred embodiment only has one resonance unit which is the second resonance unit 116.

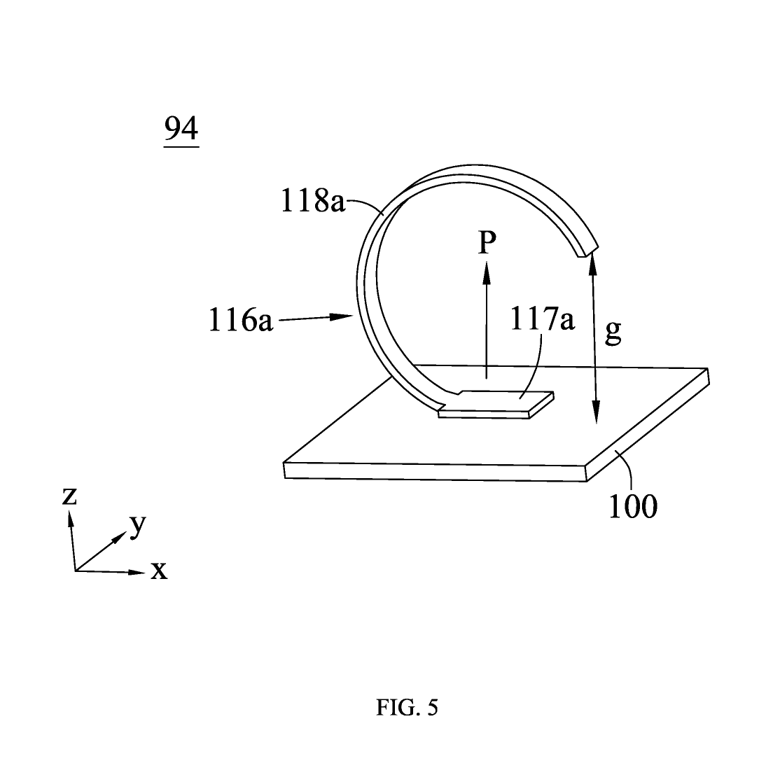

With reference to FIG. 5 for a perspective view of a metamaterial structure in accordance with the third preferred embodiment of the present invention, the resonance unit 116a of the metamaterial structure 94 only has one arm 118a and an adhesive element 117a, and a gap g is formed between the arm 118a and a surface of the substrate 100. In this preferred embodiment, the size and direction of the gap can be changed to adjust the resonance frequency of the incident light and resonance strength.

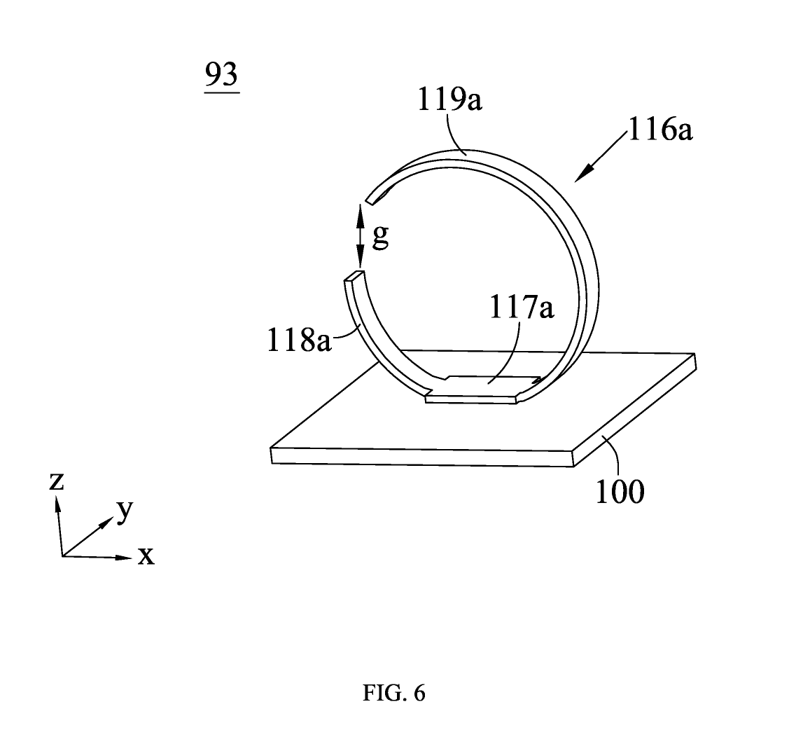

With reference to FIG. 6 for a perspective view of a metamaterial structure in accordance with the fourth preferred embodiment of the present invention, the resonance unit 116a of the metamaterial structure 93 has arms 118a and 119a. By adjusting the length of the arms 118a and 119a, the size and direction of the gap g can be changed to adjust the resonance frequency of the incident light and resonance strength.

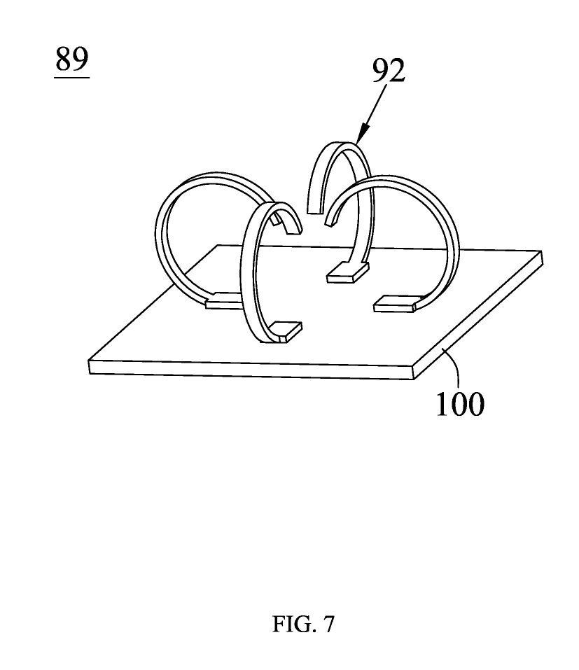

With reference to FIG. 7 for a perspective view of a metamaterial structure in accordance with the fifth preferred embodiment of the present invention, the metamaterial structure 89 arranges the metamaterial structure 94 of the third preferred embodiment into a circular shape to produce a toroidal response of the incident light.

In summation of the description above, the metamaterial of the 3D split ring resonance structure of the present invention comes with a 3D split ring resonator, so that the coupling efficiency of the incident light can be improved. With the plurality of resonance units, an optical metamaterial with the effect of negative index of refraction can be manufactured.

In addition, the whole metamaterial structure of the present invention except the adhesive element is free standing at the structure of the substrate, so that an external environmental change including a change of temperature, electric field, or magnetic field can change adjust the geometric appearance and change the resonance frequency for manufacturing an in-situ reconfigurable metamaterial.

While the means of specific embodiments in present invention has been described by reference drawings, numerous modifications and variations could be made thereto by those skilled in the art without departing from the scope and spirit of the invention set forth in the claims.

What is claimed is:

1. A metamaterial structure, comprising:
a substrate, having a bump formed on a surface of the substrate;
a first resonance unit, including a first adhesive element and a first arm, and the first adhesive element being disposed along an adhesive direction of the bump, and the first arm being extended outwardly from the first adhesive element; and
a second resonance unit, including a second adhesive element and a second arm, and the second adhesive element being disposed along the adhesive direction of the first adhesive element, and the second arm being extended outwardly from the second adhesive element and curled in an opposite direction from the surface of the substrate.

2. The metamaterial structure of claim 1, further comprising an adhesive portion coupled to the first adhesive element and the second adhesive element, and the bump being coupled to the substrate and the first adhesive element, and the adhesive portion having an appearance smaller than the first adhesive element and the second adhesive element, and the bump having an appearance smaller than the first adhesive element.

3. The metamaterial structure of claim 2, wherein the first adhesive element has a first sidewall, and the second adhesive element has a second sidewall, and the first arm is extended outwardly from the first sidewall, and a portion of the first arm coupled to the first adhesive element has an appearance smaller than the first sidewall, and the second arm is extended outwardly from the second sidewall, and a portion of the second arm coupled to the second adhesive element has an appearance smaller than the second sidewall.

4. A manufacturing method of a metamaterial structure, comprising:
providing a substrate, and defining a contour on a surface of the substrate, and the contour including an adhesive area and an arm area extended outwardly from the adhesive area;
depositing a first metal layer on the substrate;
depositing a connecting layer on the first metal layer;
depositing a second metal layer on the connecting layer, and the second metal layer having a stress for curling in an opposite direction from the surface of the substrate;
forming the contour with the first metal layer, the second metal layer and the connecting layer by a lift-off process; and
etching the arm area and a portion of the connecting layer corresponding to the arm area to curl a portion of the second metal layer corresponding to the contour of the arm area to form the metamaterial structure.

5. The manufacturing method of claim 4, wherein the arm area is extended outwardly from a side of the adhesive area and a portion of the arm area coupled to the adhesive area is smaller than the side of the adhesive area.

6. The manufacturing method of claim 4, wherein the step of etching the arm area and the portion of the substrate corresponding to the contour of the arm area is performed by using a dry etching method or a wet etching method.

7. The manufacturing method of claim 4, wherein the step of defining the contour is performed by using an electron beam lithography, a photolithography, a focused ion beam, a nano imprinting or a laser direct beam.

8. A metamaterial structure, comprising:
a substrate, having a first bump formed on a surface of the substrate; and
a first resonance unit, including:
a first adhesive element, adhered onto the first bump; and
a first arm, extended outwardly from the first adhesive element and curled in an opposite direction from the surface of the substrate.

9. The metamaterial structure of claim 8, wherein the first arm and the surface of the substrate define a gap therebetween.

10. The metamaterial structure of claim 8, wherein the first arm is extended outwardly from a sidewall of the first adhesive element, and a portion of the first arm coupled to the first adhesive element has an appearance smaller than that of the sidewall.

11. The metamaterial structure of claim 8, wherein the first resonance unit further includes a second arm, and the first adhesive element has a first sidewall and a second sidewall disposed opposite to each other, and the first arm is extended outwardly from the first sidewall, and the second arm is extended outwardly from the second sidewall, and a portion of the first arm coupled to the first adhesive element has an appearance smaller than that of the first sidewall, and a portion of the second arm coupled to the first adhesive element has an appearance smaller than that of the second sidewall.

12. The metamaterial structure of claim 11, wherein the first arm has a length equal to or greater than that of the second arm, and a gap is formed between the first arm and the second arm.

13. A metamaterial structure, comprising:
a substrate, having a plurality of bumps formed on a surface of the substrate, and the bumps being arranged in a circular array or a rectangular array; and
a plurality of resonance units, coupled to the bumps one by one, and each of the resonance unit including:
a first adhesive element, adhered onto a first bump among the plurality of bumps; and
a first arm, extended outwardly from the first adhesive element and curled in an opposite direction from the surface of the substrate.

14. The metamaterial structure of claim 13, wherein the first arm and the surface of the substrate define a gap therebetween.

15. The metamaterial structure of claim 13, wherein the first arm is extended outwardly from a sidewall of the first adhesive element, and a portion of the first arm coupled to the first adhesive element has an appearance smaller than that of the sidewall.

16. The metamaterial structure of claim 13, wherein the resonance unit further includes a second arm, and the first adhesive element has a first sidewall and a second sidewall disposed opposite to each other, and the first arm is extended outwardly from the first sidewall, and the second arm is extended outwardly from the second sidewall, and a portion of the first arm coupled to the first adhesive element has an appearance smaller than that of the first sidewall, and a portion of the second arm coupled to the first adhesive element has an appearance smaller than that of the second sidewall.

17. The metamaterial structure of claim 16, wherein the first arm has a length equal to or greater than that of the second arm, and a gap is formed between the first arm and the second arm.
